(19) United States
(12) Patent Application Publication
(10) Pub. No.: US 2006/0238528 A1
(43) Pub. Date: Oct. 26, 2006

(54) Driving apparatus and driving method for electron emission device

(76) Inventors: Mun Seok Kang, Anyang (KR); Chul Ho Lee, Cheonan (KR)

Correspondence Address: CHRISTIE, PARKER & HALE, LLP, PO BOX 7068, PASADENA, CA, 91109-7068, US

(21) Appl. No.: 11/384,101

(22) Filed: Mar. 17, 2006

(30) Foreign Application Priority Data
Mar. 29, 2005 (KR) 10-2005-0026172

(51) Int. Cl. G09G 5/00

(52) U.S. Cl. 345/204

(57) ABSTRACT

A driving apparatus and a driving method for an electron emission device include a polarity operator for receiving an external video data signal and a horizontal synchronization signal, and generating a polarity control signal in response to the horizontal synchronization signal. The apparatus further includes a data inverter for selectively inverting video data output from the polarity operator, a serial-parallel converter for converting video data output from the data inverter into parallel data, a pulse width modulator for modulating a pulse width of the parallel data output from the serial-parallel converter, and a polarity controller for selectively inverting a signal output from the pulse width modulator.

### CROSS-REFERENCE TO RELATED APPLICATIONS

This application claims priority to and the benefit of Korean Patent Application No. 10-2005-0026172, filed on Mar. 29, 2005, in the Korean Intellectual Property Office, the entire disclosure of which is incorporated herein by reference.

### BACKGROUND

1. Field of the Invention

The present invention relates to a driving apparatus and a driving method for an electron emission device.

2. Discussion of Related Art

In a typical flat panel display (FPD), a container is formed by sealing two substrates with a lateral wall standing therebetween, and proper materials are arranged within the container so as to display a desired image. Various types of flat panel displays, such as a liquid crystal display (LCD), a plasma display panel (PDP), an electron emission display, etc. have recently been developed.

Particularly, an electron emission display employs an electron beam for making a fluorescent material emit light, similar to a cathode ray tube (CRT). Thus, the electron emission display has beneficial qualities of both a CRT and a flat panel display, namely, low power consumption and non-contorted image display. Further, electron emission displays are highly expected to emerge as next generation displays because of their fast response time, high brightness, fine pitch, thinness, etc.

In general, an electron emission device uses a hot cathode or a cold cathode as an electron source. The types of electron emission devices using a cold cathode, include a field emitter array (FEA) type, a surface conduction emitter (SCE) type, a metal-insulator-metal (MIM) type, a metal-insulator-semiconductor (MIS) type, a ballistic electron surface emitting (BSE) type, etc.

An electron emission display has a triode structure of a cathode electrode, an anode electrode and a gate electrode. In more detail, the cathode electrode generally used as a scan electrode is formed on a substrate, and an insulating layer formed with a hole and the gate electrode generally used as a data electrode are formed on the cathode electrode in sequence. Then, an emitter is formed as the electron source within the hole, and the emitter contacts the cathode electrode.

In the electron emission display with this configuration, the emitter emits electrons by focusing a high electric field thereon, which can be explained by the quantum tunneling effect. The electrons emitted from the emitter are accelerated by a voltage applied between the cathode electrode and the anode electrode, and collide with red, green, and blue (RGB) fluorescent materials provided on the anode electrode, so that the fluorescent materials emit light, thereby displaying a predetermined image.

Here, the brightness of an image displayed as the emitted electrons collide with the fluorescent materials is varied according to values of an input digital video signal. In more detail, the digital video signal has a value of 8 bits corresponding to each of red (R), green (G), and blue (B) data. That is, the digital video signal has a value ranging from 0 (00000000₍₂₎) to 255 (1111111₍₂₎). Thus, 256 gray levels can be represented with 256 values of the digital video signal, and the brightness of color is represented by the digital values.

In general, a pulse width modulation (PWM) method or a pulse amplitude modulation (PAM) method is used to control the brightness represented by the values of the digital video signal.

The PWM method modulates the pulse width of a driving waveform applied to the data electrode in accordance with the digital video signals input from a data electrode driver. When the digital video signal having a value of 255 is input within the allowable maximum on-time, the pulse width is maximized, thereby maximizing the brightness. When the digital video signal has a value of 127, the pulse width is reduced to half of the maximum pulse width, thereby controlling the brightness correspondingly.

On the other hand, the PAM method keeps the pulse width constant regardless of the input digital video signal, and modulates the pulse voltage level, i.e., the pulse amplitude of the driving waveform applied to the data electrode in accordance with the input digital video signal, thereby controlling the brightness.

FIG. 1 illustrates waveforms of input/output signals of a conventional data driver. As shown therein, input/output signals of the data driver include a horizontal synchronization signal Hsync; a polarity control signal POL; a video data input signal Input Data, which is input to the data driver; and a video data output signal Driver Output, which is output from the data driver.

The video data input signal is inputted in correspondence with the horizontal synchronization signal as a periodic signal for a data line. Here, the video data input signal is converted to have a corresponding pulse width by a pulse width modulation (PWM) method.

For example, in the case where the video data input signals having values of ‘128’, ‘64’, ‘200’ and ‘100’ are inputted in sequence, the video data input signals are converted to have pulse widths of “Ta”, “Tb”, “Tc” and “Td” corresponding to the values of ‘128’, ‘64’, ‘200’ and ‘100’. Here, the pulse widths of “Ta”, “Tb”, “Tc” and “Td” correspond to brightness levels, respectively.

Further, the polarity control signal is used for switching the polarity of the video data output signal output from the data driver. For example, when the polarity control signal has a low level and the video data input signal having a high level is input to the data driver, the data driver outputs the video data output signal having a low level.

When the video data output signal has the pulse widths of “Ta”, “Tb”, “Tc” and “Td”, a switching frequency is determined in accordance with the resolution of the video data output signal. That is, the switching frequency becomes higher as the resolution increases, thereby increasing power consumption.

In a driving apparatus for an electron emission device having a matrix structure, a video signal applied to a data line is converted to have a pulse width corresponding to a predetermined voltage level, and the polarity is switched in proportion to a horizontal resolution. Thus, the number of polarity switches of the video signal corresponds to the horizontal resolution.

Here, the power consumption in a data electrode of the electron emission device can be calculated by the following equation.
P=c×ΔV²×f

Where, P is a power consumption in the data electrode, c is a line capacitance of a display panel, ΔV is a voltage variation of the video signal, and f is a switching frequency.

Thus, the conventional driving apparatus and method have generally high power consumption for driving the electron emission device.

### SUMMARY OF THE INVENTION

Accordingly, in one aspect of the present invention, a driving apparatus and a driving method for an electron emission device include a polarity control function provided in a data driver. An output signal having a modulated pulse width is switched less frequently than in the conventional art, thereby reducing the total power consumption.

In one embodiment of the present invention, a driving apparatus for an electron emission device includes a polarity operator for receiving an external video data signal and a horizontal synchronization signal, and generating a polarity control signal in response to the horizontal synchronization signal. A data inverter is coupled to the polarity operator and selectively inverts video data output from the polarity operator. A serial-parallel converter is coupled to the data inverter and converts video data output from the data inverter into parallel data. A pulse width modulator is coupled to the serial-parallel converter and modulates a pulse width of the parallel data output from the serial-parallel converter. A polarity controller is coupled to the pulse width modulator and selectively inverts a signal output from the pulse width modulator.

According to an embodiment of the present invention, the polarity operator includes a D flip-flop and a data determiner.

In another embodiment of the present invention, a method of driving an electron emission device includes switching a polarity control signal in correspondence to a horizontal synchronization signal and selectively inverting a video data signal on the basis of the switched polarity control signal. A pulse width of the video data signal is mixed with a pulse width of the selectively inverted video data signal every two lines of a plurality of lines.

### BRIEF DESCRIPTION OF THE DRAWINGS

These and/or other aspects and features of the invention will become apparent and more readily appreciated from the following description of the examples of embodiments, taken in conjunction with the accompanying drawings of which:

FIG. 1 illustrates waveforms of input/output signals of a conventional data driver;

FIG. 2 is a control block diagram of a driving apparatus for an electron emission device according to an embodiment of the present invention;

FIG. 3 is a schematic diagram of a polarity operator of the embodiment shown in FIG. 2;

FIG. 4 illustrates a waveform of a polarity control signal switched corresponding to a blanking signal of the embodiment shown in FIG. 3;

FIG. 5 is a schematic diagram of a data converter of the embodiment shown in FIG. 2; and

FIG. 6 illustrates waveforms of signals output from the driving apparatus of the embodiment shown in FIG. 2.

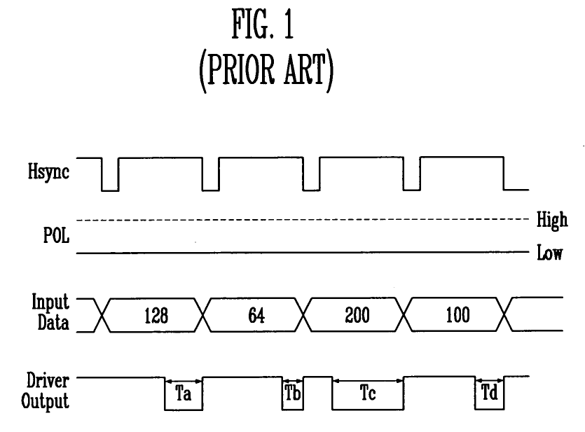

### DETAILED DESCRIPTION

Hereinafter, examples of embodiments according to the present invention will be described with reference to the accompanying drawings, wherein the examples of embodiments of the present invention are provided to be readily understood by those skilled in the art.

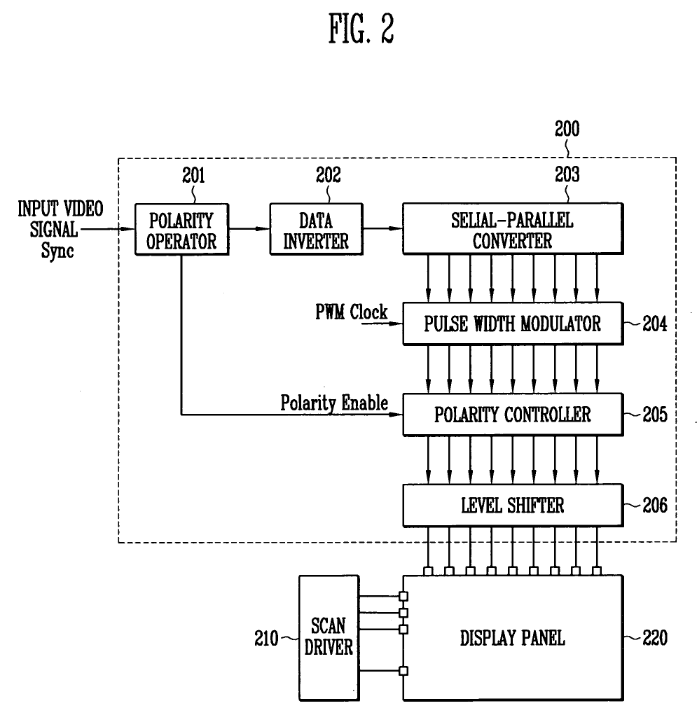

FIG. 2 is a control block diagram of a driving apparatus for an electron emission device according to an embodiment of the present invention. As shown therein, an electron emission device according to an embodiment of the present invention includes a data driver 200, a scan driver 210, and a display panel 220.

The data driver 200 includes a polarity operator 201 receiving a video data signal and a horizontal synchronization signal, and generating a polarity control signal corresponding to the horizontal synchronization signal. The data driver 200 also includes a data inverter 202 selectively inverting the video data signal output from the polarity operator 201, and a serial-parallel converter 203 converting the video data signal output from the data inverter 202 into parallel data. A pulse width modulator 204 is also included for modulating the pulse width of the parallel data output from the serial-parallel converter 203. A polarity controller 205 selectively inverts a signal output from the pulse width modulator 204 on the basis of the polarity control signal.

In one embodiment, the data driver 200 further includes a level shifter 206 adjusting a brightness level of the video data signal output from the polarity controller 205, a display panel 220 displaying an image thereon, and a scan driver 210 generating an on-time determination signal for a scan signal applied to the display panel 220.

Referring to FIGS. 2 and 3, the polarity operator 201 receives a video signal along with the horizontal synchronization signal and a vertical synchronization signal. At this time, the polarity operator 201 generates a polarity control signal POL_CON for switching the polarity of the video signal in correspondence to the received horizontal synchronization signal.

That is, the polarity control signal alternates between a high level and a low level according to a periodic signal applied to its input line. Further, the polarity control signal is repeated every two data lines.

The data inverter 202 receives the video data signal and the polarity control signal from the polarity operator 201, and inverts the video data signal on the basis of the polarity control signal.

For example, in this embodiment, when the video data signal should be inverted while the polarity control signal has the high level, the video data signal is output without the inversion while the polarity control signal has the low level.

The serial-parallel converter 203 receives the video data signal inverted corresponding to the polarity control signal from the data inverter 202 in series, and converts the serial video data signal into a parallel signal, thereby outputting the parallel signal to a data electrode of the display panel 220.

The pulse width modulator 204 modulates the pulse width of the parallel video data signal in accordance with a PWM frequency clock signal, thereby generating a PWM signal. That is, the pulse width modulator 204 receives information about PWM and an on-time from a PWM clock generator (not shown), in which the information about the PWM and the on-time is converted on the basis of a PWM clock converting index and an on-time converting index.

The polarity controller 205 receives the PWM signal from the pulse width modulator 204 and the polarity control signal from the polarity operator 201 at the same time, and selectively controls the polarity of the PWM signal on the basis of the polarity control signal.

The level shifter 206 generates a voltage to be applied to the data electrode of the display panel 220. Here, the level shifter 206 shifts the voltage level of the video data signal output from the polarity controller 205.

The scan driver 210 applies a low signal or a high signal to a predetermined scan line of the display panel 220 for a predetermined period in response to the on-time, thereby selecting a predetermined scan line among scan lines (not shown). Here, the scan signal 210 generates the on-time determination signal based on the received on-time.

The display panel 220 includes a plurality of data lines formed as gate or cathode electrodes, a plurality of scan lines formed as the other of the gate or cathode electrodes, and a plurality of pixels formed in regions where the data lines intersect the scan lines. The pixel includes the gate electrode and the cathode electrode, and receives a data signal and a scan signal through the data line and the scan line, respectively. Here, a plurality of pixels are selected in sequence by the scan signals input through the scan lines, and the selected pixels receive the data signal through the data line and emit light, so that the pixels emit light, thereby displaying a predetermined image.

FIG. 3 schematically illustrates a configuration of the polarity operator in FIG. 2. As shown therein, the polarity operator 201 includes a D flip-flop 301, and a data determiner 302.

In more detail, the horizontal synchronization signal including a blanking signal at regular intervals is input to the D flip-flop 301 of the polarity operator 201, and at the same time a polarity enable signal is input to the D flip-flop 301 without variation of the polarity. In the D flip-flop 301, the polarity enable signal is switched by the blanking signal and then output as the polarity control signal.

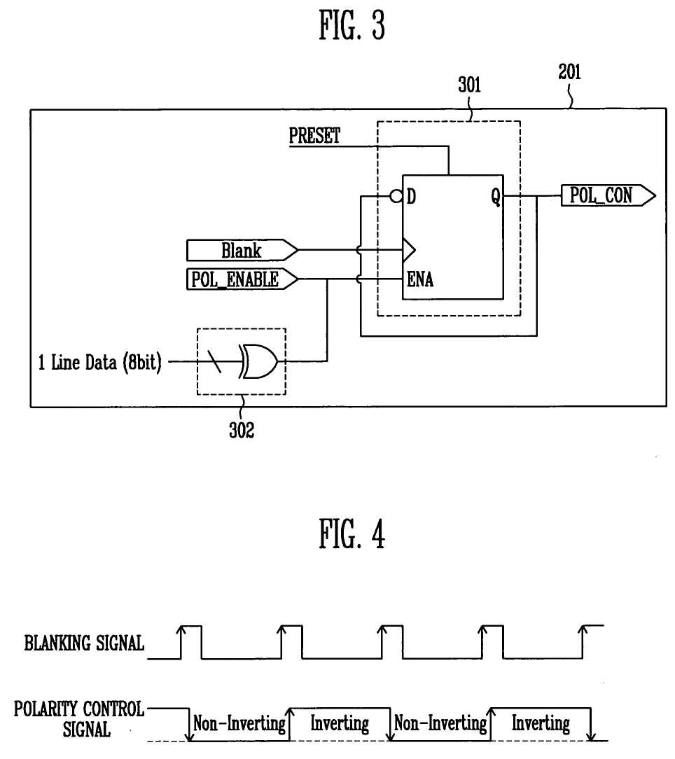

FIG. 4 illustrates a waveform of a polarity control signal switched corresponding to a blanking signal of FIG. 3. As shown therein, when both the input signals are all “0”, the polarity enable signal is “1”. At this time, a preset signal (“0” or “1”) is inverted at a rising edge of the input blanking signal and then output. Thus, the level of the polarity control signal is repeatedly switched at the rising edge of the blanking signal.

At this time, the polarity operator 201 is provided in a data driver and generates the polarity control signal in itself by the received blanking signal, thereby reducing a timing error arising when a driver control signal is input from a timing controller (not shown).

Further, the polarity enable signal is determined with respect to the video signal corresponding to one line. Thus, the data determiner 302 includes a logic circuit such as an exclusive-OR, so that the signals of all “0 (black)” or all “1 (white)” are used as the polarity enable signal for the D flip-flop 301.

In more detail, when the video data signals corresponding to two lines are all black (0) or white (255), a waste switching operation is performed by the polarity control signal, thereby increasing power consumption due to the switching operation. To prevent the waste switching operation, the data determiner 302 determines whether data is of “0” or “1” every two lines. Here, the data determiner 302 determines the video data signal having a black level (0) as “0” and the video data signal having a white level (255) as “1”.

That is, when the input signals corresponding to two lines are all “0 (black)” or all “1 (white)”, the polarity control signal is controlled to be not switched and the video data signal is controlled to be not inverted. These controls can be easily processed by a line memory unit (not shown), other combination logic circuits (not shown), etc.

Therefore, the polarity control signal generated by the polarity operator 201 selects the input video data of 8 bits as being distinguished between inversion and non-inversion, thereby inverting the polarity of data according to “1” or “0” of the polarity control signal.

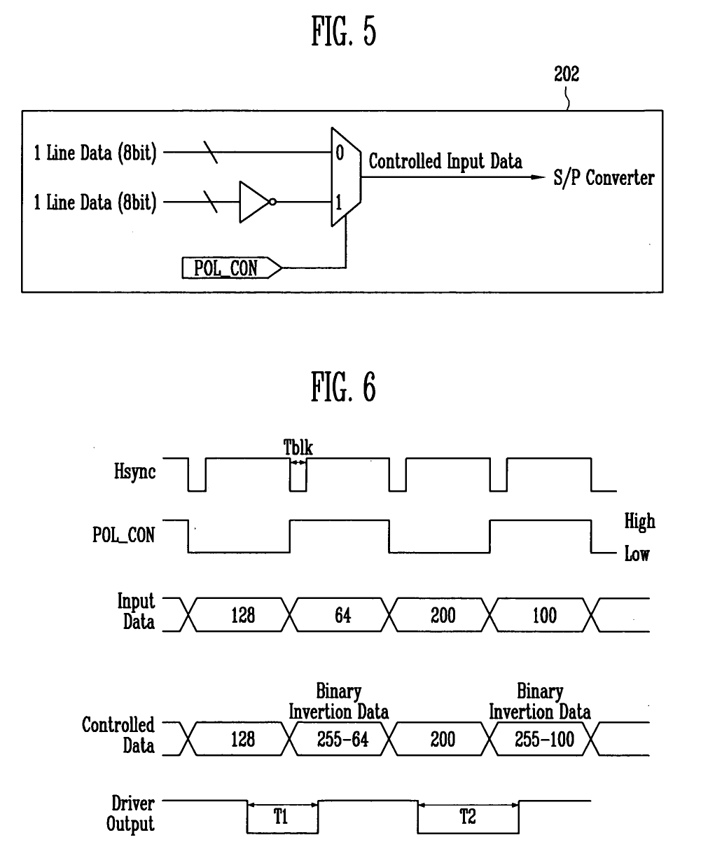

FIG. 5 schematically illustrates a configuration of the data inverter in FIG. 2. As shown therein, the data inverter 202 controls the received video data signal on the basis of the polarity control signal of the polarity operator 201 (FIG. 2).

In more detail, the video data signal output from the data inverter 202 is switched every two lines. For example, in a case where the first video data input signal has a level of “128” and the following video data input signal has a level of “64”, the second input video data is processed by a binary inversion to have a level of “255-64”.

Then, a pulse width frequency is generated after the inverted video data signal is input to the serial-parallel converter 203.

Therefore, the pulse width frequency controls the signal obtained by mixing the video data signal having a level of “128” with the binary inverted video data signal having a level of “255-64” to be switched once every two lines.

A driving method for the electron emission device according to an embodiment of the present invention is as follows.

FIG. 6 illustrates waveforms of signals output from the driving apparatus in FIG. 2. As shown therein, input/output signals of the data driver include a horizontal synchronization signal Hsync; a polarity control signal POL_CON; a video data input signal Input Data, which is input to the data driver; a binary inverted video data signal Controlled Data; and a video data output signal Driver Output, which is output from the data driver.

The polarity operator 201 receives the video data signal along with the horizontal synchronization signal and the vertical synchronization signal. At this time, the polarity control signal is generated for switching the polarity of the video signal in correspondence to the received horizontal synchronization signal. Further, the video data signal is input in response to the horizontal synchronization signal used as a periodic signal for the data line.

In more detail, the horizontal synchronization signal includes the blanking signal in accordance with the on-time corresponding to one line of the video data input signal. At this time, the polarity control signal alternates between high and low according to a blanking period, and is repeatedly generated every two lines.

Further, the data inverter 202 receives the video data signal and the polarity control signal from the polarity operator 201, and inverts the video data signal on the basis of the polarity control signal. That is, the data inverter 202 selectively switches the video data signal into the binary inverted video data signal on the basis of the polarity control signal.

The video data signal output from the data inverter 202 is switched every two lines. For example, in the case where the video data input signals have levels of “128”, “64”, “200” and “100”, the first video data signal having a level of “128” is output without inversion on the basis of the polarity control signal, and the second video data signal having a level of “64” is switched by the binary inversion to have a level of “255-64” on the basis of the polarity control signal.

Further, the third video data signal having a level or “200” is output as a non-inversion signal, and the fourth video data signal having a level of “100” is output as a binary inversion signal having a level of “255-100”.

Thus, the polarity of the binary inverted video data signal output from the data inverter 202 is controlled on the basis of the polarity control signal, so that the video data input signal is output as the pulse width frequency.

For example, when the video data signals having levels of “128”, “64”, “200” and “100” are input in sequence, one pulse width frequency is output by mixing the video data signal having a gray level of “128” with the binary inverted video data signal having a gray level of “255-64”, and another pulse width frequency is output by mixing the video data signal having a gray level of “200” with the binary inverted video data signal having a gray level of “255-100”.

Thus, the video data output signal has a pulse width of “T1” corresponding to the gray level sum of “128” and “255-64”, and a pulse width of “T2” corresponding to the gray level sum of “200” and “255-100”. Likewise, the binary inverted video data signals are repeatedly switched as one pulse width frequency every two lines.

On the other hand, when the video data signals corresponding to two lines are all black (0) or white (255), a waste switching operation may be performed by the polarity control signal, thereby increasing power consumption due to the switching operation.

To prevent the waste switching operation, the polarity operator 201 determines whether the video data signals sequentially input in response to the polarity control signal are of “0” or “1” every two lines. Here, the data determiner 302 determines the video data signal having a black level (0) as “0” and the video data signal having a white level (255) as “1”.

That is, when the input signals corresponding to two lines are all “0 (black)” or all “1 (white)”, the polarity control signal is controlled to be not switched and the video data signal is controlled to be not inverted.

Therefore, when it is determined that the video data input signals of “1” and “0” corresponding to two lines are sequentially inputted, the video data signals are controlled to be not switched into the binary inverted video data signal.

Thus, in the driving method according to an embodiment of the present invention, the switching operation for the pulse width frequency output from the driver is performed once every two lines, i.e. reduced to half, thereby reducing total power consumption.

Further, a desired gray level can be represented by applying the signal of the scan driver and the pulse width of the data driver according to the horizontal synchronization signal.

As described above, the present invention provides a driving apparatus and a driving method for an electron emission device, in which a polarity control function is provided in a data driver, and an output signal having a modulated pulse width is switched less, thereby reducing total power consumption.

While the invention has been described in connection with certain exemplary embodiments, it is to be understood by those skilled in the art that the invention is not limited to the disclosed embodiments, but, on the contrary, is intended to cover various modifications included within the sprit and scope of the appended claims and equivalents thereof.

What is claimed is:

1. A driving apparatus for an electron emission device, comprising:
a polarity operator for receiving an external video data signal and a horizontal synchronization signal, generating a polarity control signal in response to the horizontal synchronization signal, and outputting video data;
a data inverter coupled to the polarity operator for selectively inverting the video data output from the polarity operator and outputting the selectively inverted video data;
a serial-parallel converter coupled to the data inverter for converting the selectively inverted video data output from the data inverter into parallel data and outputting the parallel data;
a pulse width modulator coupled to the serial-parallel converter for modulating a pulse width of the parallel data output from the serial-parallel converter and outputting a pulse width modulated signal; and
a polarity controller coupled to the pulse width modulator for selectively inverting the pulse width modulated signal output from the pulse width modulator.

2. The driving apparatus according to claim 1, wherein the polarity controller outputs a video data signal to a level shifter coupled to the polarity controller for controlling a brightness level of the video data signal output from the polarity controller.

3. The driving apparatus according to claim 1, wherein the horizontal synchronization signal inputted to the polarity operator includes a blanking signal at predetermined intervals, and the polarity control signal is generated in correspondence to the blanking signal.

4. The driving apparatus according to claim 1, wherein the polarity operator comprises a D flip-flop and a data determiner.

5. The driving apparatus according to claim 4, wherein the D flip-flop of the polarity operator receives the horizontal synchronization signal and a polarity enable signal, and the polarity control signal is switched corresponding to the blanking signal of the horizontal synchronization signal.

6. The driving apparatus according to claim 4, wherein the data determiner of the polarity operator determines whether the inputted external video data signal that corresponds to one of a plurality of lines has a black level or a white level.

7. The driving apparatus according to claim 4, wherein the data determiner outputs a determined signal to the D flip-flop, and the D flip-flop outputs the polarity control signal corresponding to the determined signal.

8. The driving apparatus according to claim 1, wherein the data inverter outputs the selectively inverted video data signal corresponding to the polarity control signal of the polarity operator.

9. The driving apparatus according to claim 1, wherein the data inverter periodically inverts the video data once every two lines of a plurality of lines.

10. The driving apparatus according to claim 1, wherein the serial-parallel converter receives the selectively inverted video data in series, and converts inverted video data of the selectively inverted video data into a parallel signal.

11. The driving apparatus according to claim 1, wherein the polarity controller selectively inverts the pulse width modulated signal on the basis of the polarity control signal.

12. A method of driving an electron emission device, comprising:
switching a polarity control signal in correspondence to a horizontal synchronization signal;
selectively inverting video data signals on the basis of the switched polarity control signal to form inverted video data signals and uninverted video data signals; and
mixing a pulse width of one of the uninverted video data signals and a pulse width of one of the inverted video data signals once every two lines of a plurality of lines.

13. The method according to claim 12, wherein the switching the polarity control signal comprises switching the polarity control signal in correspondence to a blanking signal included in the horizontal synchronization signal.

14. The method according to claim 12, wherein the switching the polarity control signal comprises repeatedly switching the polarity to alternate between high and low polarity once every two lines.

15. The method according to claim 12, wherein the switching the polarity control signal comprises determining the video data signals that correspond to two sequential lines.

16. The method according to claim 15, wherein the determining the video data signals comprises preventing the switching of the polarity control signal when the video data signals corresponding to the two lines are both input as 1 or both input as 0.

17. The method according to claim 15, the determining the video data signals comprises preventing binary inversion of the video data signals when the video data signals corresponding to the two lines are both input as 1 or both input as 0.

18. An electron emission device comprising:
a display panel;
a scan driver coupled to the display panel; and
a data driver coupled to the display panel, the data driver comprising:
a polarity operator for receiving an external video data signal and a horizontal synchronization signal, generating a polarity control signal in response to the horizontal synchronization signal, and outputting video data;
a data inverter coupled to the polarity operator for selectively inverting the video data output from the polarity operator and outputting the selectively inverted video data;
a serial-parallel converter coupled to the data inverter for converting the selectively inverted video data output from the data inverter into parallel data and outputting the parallel data;
a pulse width modulator coupled to the serial-parallel converter for modulating a pulse width of the parallel data output from the serial-parallel converter and outputting a pulse width modulated signal; and
a polarity controller coupled to the pulse width modulator for selectively inverting the pulse width modulated signal output from the pulse width modulator.

19. The electron emission device according to claim 18, wherein the polarity controller outputs a video data signal, and wherein the data driver further comprises a level shifter coupled to the polarity controller for controlling a brightness level of the video data signal output from the polarity controller.

20. The electron emission device according to claim 18, wherein the polarity operator comprises a D flip-flop and a data determiner.
